(19) United States
(12) Patent Application Publication
(10) Pub. No.: US 2025/0164186 A1
(43) Pub. Date: May 22, 2025

(54) DRYING SYSTEM

(71) Applicant: SK ON CO., LTD., Seoul (KR)

(72) Inventors: Yun Jong KIM, Daejeon (KR); Se Hun PARK, Daejeon (KR); Ji Yun YANG, Daejeon (KR); Dong Young JUNG, Daejeon (KR)

(21) Appl. No.: 18/889,381

(22) Filed: Sep. 19, 2024

(30) Foreign Application Priority Data
Nov. 20, 2023 (KR) 10-2023-0160715

(51) Int. Cl. F26B 21/12; F26B 21/10; H01M 10/04

(52) U.S. Cl. CPC F26B 21/12; F26B 21/10; H01M 10/0404

(57) ABSTRACT

Proposed is a drying system. The drying system includes an air mixing part in which air introduced from an outside and an exhaust air are mixed with each other, a heat exchanger in which air from the air mixing part is heated, a heater part in which air supplied from the heat exchanger is heated, a drying room to which air heated from the heater part is supplied, a first damper coupled to a front end of the air mixing part so as to adjust an air amount, a first connection line to which a second damper is coupled so that the exhaust air is introduced into the air mixing part, a second connection line to which a third damper is coupled so that the exhaust air is introduced into the heat exchanger, and a first hygrometer configured to measure humidity of air supplied from the heat.

### CROSS REFERENCE TO RELATED APPLICATION

The present application claims priority to Korean Patent Application No. 10-2023-0160715, filed Nov. 20, 2023, the entire contents of which are incorporated herein for all purposes by this reference.

### BACKGROUND OF THE INVENTION

### Field of the Invention

The present disclosure relates to a drying system.

### Description of the Related Art

Generally, a secondary battery is a battery which converts chemical energy into electrical energy and which is capable of being repeatedly used through a charging process that is a reverse process of a discharging process. Furthermore, various types of secondary batteries are being developed, and the types of secondary batteries include a nickel-cadmium (Ni—Cd) battery, a nickel-hydrogen (Ni—MH) battery, a lithium-metal battery, a lithium-ion (Ni-Ion) battery, a lithium-ion polymer battery (Li-Ion Polymer Battery, which is hereinafter referred to as “LIPB”), and so on.

Recently, since a secondary battery has been widely used in the IT product field, the automobile field, the energy storage field, and so on, the secondary battery has been attracting attention as an energy source. In the IT product field, a secondary battery capable of being continuously used for a long time and being capable of realizing miniaturization and weight reduction is required. In the automobile field, a secondary battery having high power, durability, stability, and so on for eliminating the risk of explosion is required. In the energy storage field, a secondary battery is widely applied for storing surplus power generated by wind power, solar photovoltaic power generation, and so on.

In a drying process of drying a solvent in a slurry and so on, which is required in a manufacturing process of a secondary battery, it is difficult to smoothly secure a drying reliability or an effective drying time with only a general rapid exhaust system. Therefore, there is a need for improvement of a drying system in the manufacturing process of the secondary battery.

### DOCUMENT OF RELATED ART

(Patent Document 1) KR 10-1475429 B1

### SUMMARY OF THE INVENTION

According to an aspect of the present disclosure, there is provided a drying system capable of effectively securing drying time of a drying process in a manufacturing process of a secondary battery and capable of increasing drying performance.

According to the present disclosure, there is provided a drying system including: an air mixing part in which air introduced from an outside and an exhaust air are mixed with each other; aheat exchanger in which air from the air mixing part is heated; a heater part in which air supplied from the heat exchanger is heated; a drying room to which air heated from the heater part is supplied; a first damper coupled to a front end of the air mixing part so as to adjust an air amount introduced into the air mixing part; a first connection line to which a second damper for adjusting an introduction amount is coupled so that the exhaust air discharged from the drying room is introduced into the air mixing part; a second connection line to which a third damper for adjusting an introduction amount is coupled so that the exhaust air discharged from the drying room is introduced into the heat exchanger; and a first hygrometer configured to measure humidity of air supplied from the heat exchanger to the heater part.

Here, the drying system may include a first air flow meter formed on a front end of the first damper so as to measure an air amount introduced into the air mixing part, and may include a second air flow meter formed on a third connection line through which air is supplied from the heat exchanger to the heater part.

In addition, the drying system may include an exhaust fan formed on a fourth connection line through which air is discharged from the heat exchanger to the outside.

In addition, the drying system may include an air supply fan coupled to a fifth connection line through which air is supplied from the heater part to the drying room.

In addition, when a measured humidity measured from the first hygrometer is equal to or less than a predetermined relative humidity, the second damper may be controlled such that an opening rate of the second damper is larger than an opening rate of the third damper. Furthermore, when the measured humidity measured from the first hygrometer is larger than the predetermined relative humidity, the second damper may be controlled such that the opening rate of the second damper is lower than the opening rate of the third damper.

In addition, when an air supply amount measured from the first air flow meter is referred to as a and an air supply amount of the drying room measured from the second air flow meter is referred to as b,

$$Conversion rate ( \% ) = ( 1 - \frac{a}{b} ) \times 100$$

when the circulation rate is equal to or less than a predetermined circulation rate, the second damper may be controlled such that an opening rate of the second damper is larger than an opening rate of the third damper. Furthermore, when the circulation rate is larger than the predetermined circulation rate, the second damper may be controlled such that the opening rate of the second damper is lower than the opening rate of the third damper.

In addition, the drying system may further include a second hygrometer configured to measure humidity of the exhaust air discharged from the drying room. Furthermore, when a measured humidity measured from the second hygrometer is equal to or less than a predetermined relative humidity, the second damper may be controlled such that an opening rate of the second damper is larger than an opening rate of the third damper. Furthermore, when the measured humidity measured from the second hygrometer is larger than the predetermined relative humidity, the second damper may be controlled such that the opening rate of the second damper is lower than the opening rate of the third damper.

The features and advantages of the present disclosure will be more clearly understood from the following detailed description based on the accompanying drawings.

The terms and words used in the present specification and claims should not be interpreted as being limited to typical meanings and dictionary definitions, but should be interpreted as having meanings and concepts relevant to the technical scope of the present disclosure based on the rule according to which an inventor can appropriately define the concept of the term to describe most appropriately the best method he or she knows for carrying out the present disclosure.

According to an embodiment of the present disclosure, there is an effect that the efficiency of the drying system may be increased and the power consumption of the drying system may be effectively reduced by mixing and recirculating a portion of air discharged from the drying room with the supply air of the drying system.

In addition, by mixing and recirculating the exhaust air discharged from the drying room of the drying system with the supply air in consideration of the circulation rate of the drying system, the humidity of the exhaust air, and so on, or by discharging the exhaust air to the outside through the heat exchanger, there are effects that thermal energy efficiency in the operation of the drying system is increased, and both the time and efficiency of drying may be effectively adjusted.

In addition, by mixing and recirculating a portion or all of the exhaust air as well as the supply air, there is an effect that a limit of the supply air amount is overcome and a stable operation of the drying system is capable of being realized.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a process flowchart of a drying system according to an embodiment of the present disclosure.

### DETAILED DESCRIPTION OF THE INVENTION

In adding reference numerals to components throughout the drawings, it is to be noted that like or similar reference numerals designate like or similar components even though the components are illustrated in different drawings.

The terms used in the present disclosure are used to describe an embodiment, and are not intended to limit the present disclosure. Singular expressions include plural expressions unless the context clearly indicates otherwise.

The drawings may be exaggerated or shown schematically for description of an embodiment. In the present disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

The terms “one”, “other”, “another”, “first”, “second”, and so on are used to differentiate one constituent element from another constituent element, and these constituent elements should not be limited by these terms.

Hereinafter, an embodiment of the present disclosure will be described in detail with reference to the accompanying drawings.

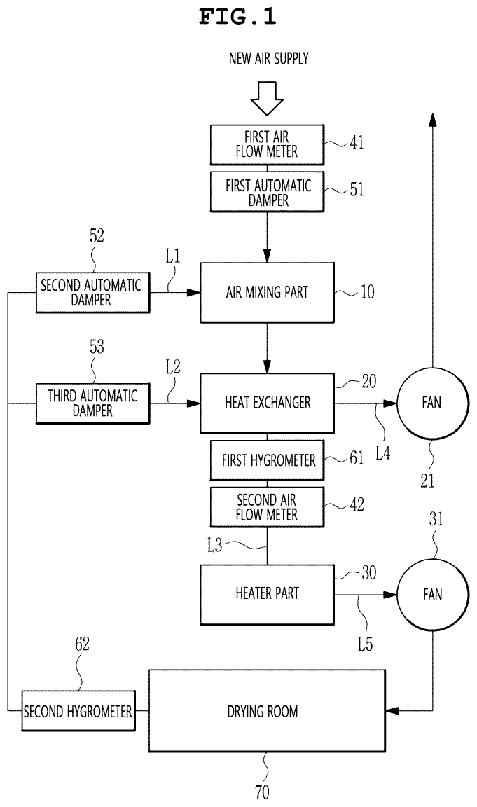

FIG. 1 is a view illustrating a process flowchart of a drying system according to an embodiment of the present disclosure.

In a drying system according to an embodiment of the present disclosure, the drying system may include an air mixing part 10 in which air introduced from the outside and an exhaust air are mixed with each other, a heat exchanger 20 in which air from the air mixing part 10 is heated, a heater part 30 in which air supplied from the heat exchanger 20 is heated, a drying room 70 to which air heated from the heater part 30 is supplied, a first damper 51 coupled to a front end of the air mixing part 10 so as to adjust an air amount introduced into the air mixing part 10, a first connection line L1 to which a second damper 52 for adjusting an introduction amount so that the exhaust air discharged from the drying room 70 is introduced into the air mixing part 10 is coupled, a second connection line 12 to which a third damper 53 for adjusting an introduction amount so that the exhaust air discharged from the drying room 70 is introduced into the heat exchanger 20 is coupled, and a first hygrometer 61 configured to measure humidity of air supplied to the heater part 30 from the heat exchanger 20.

As illustrated in FIG. 1, the air mixing part 10 is a place in which air introduced from the outside and all or a portion of air discharged from the drying room 70 are mixed with each other. A portion or all of air discharged from the drying system may be mixed with a supply air again and then may be circulated through the air mixing part 10. That is, in addition to air supplied simply from the outside, all or a portion of the exhaust air discharged from the drying room 70 may be recirculated, so that efficiency of the drying system or an external air supply amount may be appropriately adjusted.

The air discharged from the drying room 70 is supplied to the air mixing part 10 through the first connection line L1, and the introduction amount of the exhaust air into the air mixing part 10 may be appropriately adjusted according to the degree of opening and closing of the second damper 52 coupled to the first connection line L1.

The air mixing part 10 may be coupled to a first air flow meter 41 that measures the air amount introduced from the outside, and may be coupled to the first damper 51 which measures the introduction amount through the first air flow meter 41 and which is capable of appropriately adjusting the introduction amount of the external air. As the air amount supplied from the outside is measured by the first air flow meter 41, the air supply amount from the outside may be appropriately adjusted according to a circulation rate of air recirculation inside the drying system.

The heat exchanger 20 is configured to recover a waste heat caused by the exhaust air, thereby being capable of further increasing efficiency of a thermal energy that heats the circulating air of the drying system. The exhaust air discharged from the drying room 70 may be supplied to the heat exchanger 20 along the second connection line L2. The third damper 53 may be coupled to the second connection line L2 so as to adjust the supply amount of the exhaust air.

In the heat exchanger 20, waste heat of the discharged air is recovered, the air supplied from the air mixing part 10 to the drying room 70 is heated, and thermal energy for heating the air may be effectively secured. Therefore, the efficiency of the entire drying system may be also increased.

The exhaust air supplied to the heat exchanger 20 is discharged to the outside through an exhaust fan 21 coupled to a fourth connection line L4 after the waste heat is recovered. Therefore, since the opening and closing and the opening rate of the third damper 53 are capable of being adjusted in consideration of the circulation rate of the drying system, the recirculation of the exhaust air in the drying system is capable of being adjusted.

The second damper 52 and the third damper 53 may be adjusted and controlled in relation with each other. That is, the second damper 52 may introduce the exhaust air into the air mixing part 10, thereby being capable of causing recirculation in the drying system. Furthermore, the third damper 53 may recover the waste heat through the heat exchanger 20 and then may discharge the exhaust air to the outside.

Therefore, the second damper 52 and the third damper 53 may appropriately adjust the number of air circulation or the circulation rate in the drying system by controlling the relative opening and closing rate or the relative opening and closing operation.

For example, when the current measured circulation rate of the drying system exceeds a predetermined circulation rate, it is appropriate to increase the amount of exhaust air discharged to the outside through the third damper 53. When the measured circulation rate is less than the predetermined circulation rate, the current circulation rate may be increased by relatively reducing the opening rate of the third damper 53 and relatively increasing the opening rate of the second damper 52.

The heater part 30 is configured to increase the temperature of air introduced through the heat exchanger 20 to the required temperature to be introduced into the drying room 70, and then is configured to supply the air to the drying room 70. The heater part 30 is a place where air introduced from the heat exchanger 20 is heated. A heating method and a heating type are not specifically limited and, of course, an appropriate heating method and an appropriate heating type may be selected and applied according to the degree of temperature increase.

Air in which the temperature thereof is increased in the heater part 30 is supplied to the drying room 70 through an air supply fan 31 coupled to a fifth connection line L5, and a drying process is capable of being performed inside the drying room 70.

The drying room 70 is a place in which a drying object is dried within a predetermined space, and the drying process in the drying room 70 is capable of being effectively performed by supplying air at an appropriate temperature suitable for the drying object in the drying room 70.

The first hygrometer 61 and a second air flow meter 42 may be mounted on a third connection line L3 through which air is supplied from the heat exchanger to the heater part 30.

By measuring the humidity of the air passing through the heat exchanger 20, the first hygrometer 61 may determine whether the exhaust air passing through the drying room 70 is recirculated.

That is, when the measured humidity measured from the first hygrometer 61 is lower than a predetermined relative humidity, the opening rate of the third damper 53 may be reduced, and the opening rate of the second damper 52 may be relatively increased.

In addition, as the opening rate of the second damper 52 increases, the air amount supplied from the outside may be sensed by the first air flow meter 41 and then may be controlled by the first damper 51 so that the air amount matches a predetermined circulation rate.

When the measured humidity measured from the first hygrometer 61 is equal to or larger than the predetermined relative humidity, the circulation rate of the third damper 53 may be increased, thereby being capable of relatively reducing the circulation of the exhaust air by the second damper 52. Of course, the third damper 53 may be fully opened or the second damper 52 may be completely closed as required.

The second air flow meter 42 may measure the air amount supplied from the air mixing part 10 to the heater part 30 in real time, thereby being capable of measuring the air amount supplied to the drying room 70.

Therefore, since the second air flow meter 42 measures the circulating air amount by air in which the external supply air and the exhaust air are mixed with each other, the air introduction amount from the outside by the first damper 51 is capable of being adjusted together.

Since the first damper 51 is capable of controlling the air amount supplied from the outside and the second damper 52 is capable of controlling the air amount recirculated to the air mixture part 10, respectively, the first damper 51 and the second damper 52 may effectively adjust the circulation rate according to the measured values of the first air flow meter 41 and the second air flow meter 42.

When the air supply amount measured from the first air flow meter 41 is referred to as a and the air introduction amount of the drying room 70 measured from the second air flow meter 42 is referred to as b, the circulation rate of the drying system may be defined as follows.

$$Circulation rate ( \% ) = ( 1 - \frac{a}{b} ) \times 100$$

When the circulation rate of the drying system is equal to or less than the predetermined circulation rate, controlling in which the second damper 52 is opened and the third damper 53 is closed may be performed. That is, the exhaust air is supplied to the air mixing part 10 so as to increase the circulation rate, and the third damper 53 is closed so as to control external discharge of the exhaust air. Here, of course, the second damper 52 and the third damper 53 may be adjusted not only by opening and closing the second damper 52 and the third damper 53 but also by adjusting the relative opening amount between the second damper 52 and the third damper 53.

In addition, when the circulation rate is larger than the predetermined circulation rate, the relative opening amount of the first damper 51 that controls the supply amount supplied from the outside and the relative opening amount of the second damper 52 for recirculating the exhaust air may be adjusted. Here, of course, only the first damper 51 may be opened, the second damper 52 for recirculating the exhaust air may be closed, and all of the exhaust air may be discharged to the outside through the third damper 53. However, for fine control of the circulation rate, not only the simple opening and closing of the dampers, but also the relative opening amount between each of the dampers may be adjusted and controlled.

In addition, of course, the mixing ratio of the external air and the exhaust air in the air mixing part may be appropriately adjusted by adjusting the air introduction amount measured from the first air flow meter 41 and the amount of air in which the external air and the exhaust air are mixed with each other measured from the second air flow meter 42.

A second hygrometer 62 may be further mounted so as to measure the humidity of the exhaust air discharged from the drying room 70. The second hygrometer 62 is configured to measure the humidity of air discharged from the drying room 70, so that the opening and closing of the second damper 52 or the opening and closing of the third damper 53 is capable of being adjusted in consideration of the drying efficiency when the exhaust air is recirculated.

That is, when the humidity of the exhaust air discharged from the drying room 70 has a large difference in the humidity of the air required for the drying system, it is more appropriate to discharge the exhaust air to the outside through the heat exchanger 20 rather than supplying andrecirculating the exhaust air to the air mixing part 10.

However, since such control is capable of adjusting air recirculation not only by measuring the humidity by the second hygrometer 62, but also by the mixing ratio of the external air and the exhaust air in the air mixing part 10, the circulation process of the drying system may be controlled in consideration of the corresponding measurement value according to the condition of the required drying system.

The present disclosure has been described in detail through specific embodiments. The embodiment is proposed to more concretely describe the present disclosure. However, the embodiment is only given for illustrating the present disclosure and those skilled in the related art will obviously understand that various alterations and modifications are possible within the scope and spirit of the present disclosure. Such alterations and modifications are duly included in the appended claims.

What is claimed is:

1. A drying system comprising:
an air mixing part in which air introduced from an outside and an exhaust air are mixed with each other;
a heat exchanger in which air from the air mixing part is heated;
a heater part in which air supplied from the heat exchanger is heated;
a drying room to which air heated from the heater part is supplied;
a first damper coupled to a front end of the air mixing part so as to adjust an air amount introduced into the air mixing part;
a first connection line to which a second damper for adjusting an introduction amount is coupled so that the exhaust air discharged from the drying room is introduced into the air mixing part;
a second connection line to which a third damper for adjusting an introduction amount is coupled so that the exhaust air discharged from the drying room is introduced into the heat exchanger; and
a first hygrometer configured to measure humidity of air supplied from the heat exchanger to the heater part.

2. The drying system of claim 1, comprising:
a first air flow meter formed on a front end of the first damper so as to measure an air amount introduced into the air mixing part; and
a second air flow meter formed on a third connection line through which air is supplied from the heat exchanger to the heater part.

3. The drying system of claim 1, comprising an exhaust fan formed on a fourth connection line through which air is discharged from the heat exchanger to the outside.

4. The drying system of claim 1, comprising an air supply fan coupled to a fifth connection line through which air is supplied from the heater part to the drying room.

5. The drying system of claim 1, wherein, when a measured humidity measured from the first hygrometer is equal to or less than a predetermined relative humidity, the second damper is controlled such that an opening rate of the second damper is larger than an opening rate of the third damper, and
when the measured humidity measured from the first hygrometer is larger than the predetermined relative humidity, the second damper is controlled such that the opening rate of the second damper is lower than the opening rate of the third damper.

6. The drying system of claim 2, wherein when an air supply amount measured from the first air flow meter is referred to as a and an air supply amount of the drying room measured from the second air flow meter is referred to as b,
$$Circulation rate ( \% ) = ( 1 - \frac{a}{b} ) \times 100$$
when the circulation rate is equal to or less than a predetermined circulation rate, the second damper is controlled such that an opening rate of the second damper is larger than an opening rate of the third damper, and
when the circulation rate is larger than the predetermined circulation rate, the second damper is controlled such that the opening rate of the second damper is lower than the opening rate of the third damper.

7. The drying system of claim 1, further comprising a second hygrometer configured to measure humidity of the exhaust air discharged from the drying room,
wherein, when a measured humidity measured from the second hygrometer is equal to or less than a predetermined relative humidity, the second damper is controlled such that an opening rate of the second damper is larger than an opening rate of the third damper, and
when the measured humidity measured from the second hygrometer is larger than the predetermined relative humidity, the second damper is controlled such that the opening rate of the second damper is lower than the opening rate of the third damper.
